(19) United States
(12) Patent Application Publication
(10) Pub. No.: US 2008/0282859 A2
(43) Pub. Date: Nov. 20, 2008

(54) AUTOMATIC PATTERN MAKING DEVICE

(75) Inventors: Lisa CAUSSE, Phoenix, AZ (US); Brett NORDIN, Scottsdale, AZ (US); Joon PARK, Seoul (KR); Bill Marmaduke, Scottsdale, AZ (US); Kathleen GEORGE, Phoenix, AZ (US); Morton LASSEN, Scottsdale, AZ (US); Henry Minns Jr., Cave Creek, AZ (US)

Correspondence Address: PILLSBURY WINTHROP SHAW PITTMAN, LLP, P.O. BOX 10500, MCLEAN, VA, 22102, UNITED STATES, 703-770-7900, 703-770-7901

(73) Assignee: XYRON, INC., Scottsdale, AZ (US)

(21) Appl. No.: 11/603,195

(22) Filed: Nov. 22, 2006

Related U.S. Application Data
Application No. 11/603,195 is a division of application No. 11/272,295, filed on Nov. 15, 2005.
(60) Provisional application No. 60/627,179, filed on Nov. 15, 2004.

(51) Int. Cl. B26D 5/20

(52) U.S. Cl. 83/76.3; 83/76.9

(57) ABSTRACT

An automatic paper cutting apparatus includes an X-Y cutter, a cutter controller, and a pattern booklet. The pattern booklet includes a plurality of pattern identifiers and a memory device with cutting instructions for each of the identified patterns. The booklet removably mounts to the cutter controller so that an operator can select a pattern from the pattern booklet and have the memory device provide the corresponding set of cutting instructions to the cutter controller. The cutter controller uses the instructions to control the X-Y cutter and cut the desired pattern. A cutting platform of the X-Y cutter has a tacky adhesive that releaseably secures a work piece to the cutting platform during cutting operations. The cutting platform includes surface features that engage a spur gear. The cutter controller selectively rotates the spur gear to drive the cutting platform in the Y direction. The apparatus may use a journaling, embossing, perforating instrument instead of the cutter to make a pattern on the work piece.

### CROSS REFERENCE

The present application is a divisional application of U.S. Ser. No. 11/272,295, filed Nov. 15, 2005, and claims the benefit of priority to U.S. provisional application No. 60/627,179, which was filed on Nov. 15, 2004, the entire contents of both applications being incorporated in their entirety by reference herein.

### BACKGROUND OF THE INVENTION

1. Field of the Invention

One invention relates to automatic X-Y cutters that cut patterns out of substantially planar work pieces such as paper. Another invention relates to a cutting mat.

2. Description of Related Art

It is known in the art to provide computer controlled X-Y cutters (see, e.g., U.S. Pat. Nos. 5,388,488 and 3,805,650). However, such X-Y cutters must be connected to a computer, rendering the entire apparatus bulky, non-portable, and expensive.

It is also known in the art to provide a set of cutting instructions on a removable floppy disk that is selectively connected to an X-Y cutter to cut a pattern corresponding to the set of cutting instructions (see U.S. Pat. Nos. 5,634,388 and 5,454,287). However, such devices are not user friendly and do not provide a simple way for an operator to choose among a plurality of patterns to be cut or to scale the size of the pattern up or down.

In X-Y cutters, it is known to use vacuum tables (i.e., tables with small suction holes in them) to hold down a work piece during a cutting operation. Unfortunately, such vacuum tables are noisy and expensive.

It is also known in the art to use a die cutter to cut paper patterns. Unfortunately, the operator must purchase a discrete, expensive die for each pattern and size that the operator wishes to make. For example, the operator must purchase 26 different dies just to have capital alphabet letters of a single size and style. Conventional die cutters also tend to be heavy and bulky because a large amount of force must be exerted on the die to punch through the paper.

### SUMMARY OF THE INVENTION

Accordingly, one aspect of one or more embodiments of this invention provides an automatic pattern cutting apparatus that is self-contained and portable, and allows a plurality of different patterns to be quickly and easily selected and cut or processed from a work piece such as paper.

Another aspect of one or more embodiments of the present invention provides a cutting/processing mat for manual or automatic cutting/processing that releaseably secures the work piece in place during the pattern making procedure, and subsequently releases the produced pattern without harm. The cutting/processing mat is inexpensive, simple, and quiet.

Another aspect of one or more embodiments of the present invention provides a pattern making apparatus for making patterns on a substantially planar work piece. The apparatus includes a housing and a work piece supporting platform mounted to the housing. The platform is constructed and arranged to support the substantially planar work piece in an X-Y plane defined by generally orthogonal X and Y directions. The apparatus includes a pattern making instrument constructed to interact with the work piece. The instrument and the platform are movable relative to one another in the X and Y directions, and in a Z direction generally orthogonal to the X and Y directions. The apparatus includes a controller operatively connected to at least one of the instrument and the platform to move the instrument and platform relative to one another in the X, Y, and Z directions. The apparatus includes a memory device operatively connected to the controller. The memory device has a plurality of sets of pattern making instructions, each useable by the controller for moving the instrument and platform relative to one another for making a corresponding pattern from the work piece. The apparatus includes an operator interface operatively connected to the controller, and a first substrate with a first set of pattern identifiers provided thereon. Each of the first set of pattern identifiers are associated with a corresponding set of pattern making instructions in the memory device. The operator interface enables an operator to select one of the sets of pattern making instructions corresponding to a desired pattern identifier to be used by the controller to move the instrument and the platform relative to one another to make a corresponding pattern from the work piece.

According to a further aspect of one or more of these embodiments, the pattern making instrument may be a cutter (paper, vinyl, etc.), an embossing instrument, a scoring instrument, a perforating instrument, or a journaling instrument.

According to a further aspect of one or more of these embodiments, the controller is capable of scaling the sets of pattern making instructions to vary a size of a pattern formed from the work piece.

According to a further aspect of one or more of these embodiments, the pattern making apparatus includes a pattern cutting apparatus, the work piece supporting platform includes a cutting platform, the pattern making instrument is a work piece cutter, the controller includes a cutter controller, the plurality of sets of pattern making instructions include a plurality of sets of cutting instructions, and the cutter controller moves the cutter and platform relative to one another to cut a pattern from the work piece.

The operator interface may include a set of operator actuated switches each associated with a corresponding one of the sets of cutting instructions in the memory device and a corresponding one of the pattern identifiers. The operator interface enables the operator to select the set of cutting instructions corresponding to the desired pattern identifier by actuating the corresponding one of the switches. The first set of pattern identifiers may be physically aligned with the set of switches such that each of the first set of pattern identifiers is physically associated with a corresponding switch. The substrate may overlie the set of switches. The set of switches may be permanently mounted to the housing, and the memory device and substrate may be assembled together and removably mounted to the housing as a unit. The memory device, set of switches, and substrate may be assembled together and removably mounted to the housing as a unit.

According to a further aspect of one or more of these embodiments, the apparatus includes a second memory device including a second plurality of sets of cutting instructions different from the first set of cutting instructions. The apparatus also includes a second substrate with a second set of pattern identifiers displayed thereon. Each of the second set of pattern identifiers is associated with a corresponding set of cutting instructions in the second memory device. The second substrate and the second memory device are assembled together. The second memory device and second substrate may be selectively mountable as a unit to the housing in place of the memory device and first substrate to provide the cutting apparatus with a wider repertoire of patterns.

According to a further aspect of one or more of these embodiments, the apparatus includes a second substrate with a second set of pattern identifiers displayed thereon, each of the second set of pattern identifiers being associated with a corresponding set of cutting instructions in the memory device. The second substrate may be selectively physically aligned with the set of switches such that each of the second set of pattern identifiers is physically associated with one of the switches. The apparatus includes a sensor that senses which substrate is physically aligned with the set of switches. The sensor operatively connects to the cutter controller to enable the cutter controller to use sets of cutting instructions associated with the pattern identifiers of the sensed substrate. The first and second substrates may be pages of a booklet, and the memory device and the booklet may be assembled together.

According to a further aspect of one or more of these embodiments, the cutter controller includes an electronic control unit that is programmed to allow an operator to select a plurality of desired patterns to be cut from a single work piece. The electronic control unit is programmed to control the cutter to sequentially cut the plurality of desired patterns from the single work piece. The apparatus may also include a display controlled by the electronic control unit. The electronic control unit visually notifies an operator using the display when additional desired patterns will not fit onto the single work piece.

According to a further aspect of one or more of these embodiments, the cutting platform has a tacky surface that is constructed and arranged to releaseably secure the work piece in place relative to the cutting platform when the cutter cuts the work piece.

According to a further aspect of one or more of these embodiments, the cutting platform includes a rigid substrate and an adhesive layer disposed on the substrate. The adhesive layer is constructed and arranged to releaseably hold the work piece in a fixed position thereon during cutting of the work piece. The apparatus may also include a layer of self healing material disposed between the adhesive layer and the rigid substrate. The apparatus may include a removable protective layer disposed on the adhesive layer to protect the adhesive layer when the pattern cutting apparatus is not being used. The selective removal of the protective layer exposes the adhesive layer to permit the work piece to be secured thereto.

According to a further aspect of one or more of these embodiments, the cutting platform is movable relative to the housing in the Y direction, and a plurality of surface features are disposed on the cutting platform. The plurality of surface features extend linearly in the Y direction. The cutter controller includes a rotational drive element having a gear that engages the surface features of the cutting platform to selectively move the cutting platform in the Y direction relative to the housing. The cutter controller may selectively move the cutter relative to the housing and cutting platform in the X and Z directions.

Another aspect of one or more embodiments of the present invention provides a pattern making system for making patterns from a substantially planar work piece. The system includes a pattern making apparatus, an operator interface operatively connected to the controller, and a memory device operatively connected to the controller. The memory device includes a plurality of sets of pattern making instructions, each useable by the controller for moving the instrument and platform relative to one another for making a corresponding pattern from the work piece. The system also includes a first set of pattern identifiers, each of the first set of pattern identifiers being associated with a corresponding set of pattern making instructions in the memory device. The operator interface enables an operator to select one of the sets of instructions corresponding to a desired pattern identifier to be used by the controller to move the pattern making instrument and the platform relative to one another to make the corresponding pattern from the work piece. At least the set of pattern identifiers and the memory device are removable from the pattern making apparatus for replacement thereof.

According to a further aspect of one or more of these embodiments, the operator interface is part of the pattern cutting apparatus.

According to a further aspect of one or more of these embodiments, at least the memory device and first set of pattern identifiers are assembled together and removable from the apparatus as a unit. The first set of pattern identifiers may be physically aligned with the set of operator actuated switches such that each of the first set of pattern identifiers is physically associated with a corresponding switch.

According to a further aspect of one or more of these embodiments, the controller is capable of scaling the sets of pattern making instructions to vary a size of a pattern formed from the work piece.

Another aspect of one or more embodiments of the present invention provides a combination including a memory device having a plurality of sets of pattern making instructions disposed therein. The memory device is releaseably operatively connectable to a pattern making apparatus for making patterns from a work piece. The combination also includes a substrate having a plurality of pattern identifiers displayed thereon. Each pattern identifier corresponds to an associated set of pattern making instructions in the memory device. The position of each pattern identifier on the substrate correlates that pattern identifier with its associated set of pattern making instructions. The substrate may be constructed and shaped to be physically aligned with the pattern making apparatus in such a way as to indicate to the operator how to select a particular set of pattern making instructions in the memory device to use to make a pattern corresponding to a selected pattern identifier. The substrate may be constructed and shaped to overlie a plurality of switches disposed on a pattern making apparatus, the physical positions of the plurality of pattern identifiers being correlated with the plurality of switches.

Another aspect of one or more embodiments of the present invention provides a pattern booklet that includes a plurality of pages, each page having a plurality of pattern identifiers displayed thereon. The booklet includes a memory device assembled with the plurality of pages, the memory device having a plurality of sets of pattern making instructions, each set of pattern making instructions corresponding to an associated pattern identifier on one of the plurality of pages. The booklet is constructed and arranged to be removably mounted to a pattern making apparatus such that the memory device provides pattern making instructions to the pattern making apparatus, and the pages indicate to an operator which sets of pattern making instructions are available in the memory device. The pages may be shaped and sized such that when the booklet is mounted to the pattern making apparatus, the pattern identifiers physically align with switches on the pattern making apparatus that are associated with a corresponding set of pattern making instructions. The pattern booklet may be constructed and arranged to operatively connect to a computer to enable an operator to selectively download at least one set of pattern making instructions to the memory device.

Additional and/or alternative advantages and salient features of the invention will become apparent from the following detailed description, which, taken in conjunction with the annexed drawings, disclose preferred embodiments of the invention.

### BRIEF DESCRIPTION OF THE DRAWINGS

Referring now to the drawings which from a part of this original disclosure:

FIGS. 1-3 are perspective views of a pattern cutting apparatus according to one embodiment of the present invention;

FIG. 4 is a partial cross-sectional view of a cutting mat of the pattern cutting apparatus of FIG. 1;

FIG. 5 is a partial cross-sectional view of a cutting mat for manual cutting according to an alternative embodiment of the present invention;

FIG. 6 is a perspective view of an operator interface of the pattern cutting apparatus shown in FIG. 2;

FIG. 7 is a perspective view of a pattern booklet for the pattern cutting apparatus of FIG. 1;

FIG. 7A is a perspective view of a pattern booklet for the pattern cutting apparatus of FIG. 1 according to an alternative embodiment of the present invention;

FIG. 8 is a block diagram of the pattern cutting apparatus of FIG. 1;

FIG. 9 is an exploded view of a cutting assembly according to an embodiment of the present invention;

FIG. 10 is a perspective view of a pattern booklet for the pattern cutting apparatus of FIG. 1 according to an alternative embodiment of the present invention;

FIG. 11 is a perspective view of a pattern making apparatus according to an alternative embodiment of the present invention;

FIG. 12 is a perspective view of a work piece supporting platform of the apparatus illustrated in FIG. 11;

FIG. 13 is a rear, partial, perspective view of the apparatus illustrated in FIG. 1;

FIG. 14 is a flowchart illustrates a method for making a pattern according to an embodiment of the present invention;

FIGS. 15A and 15B are perspective and side views, respectively, of a cutter for use with the apparatus of FIG. 1 according to an embodiment of the present invention;

FIGS. 16A and 16B are perspective and side views, respectively, of a journaling instrument for use with the apparatus of FIG. 1 according to an embodiment of the present invention;

FIGS. 17A and 17B are perspective and side views, respectively, of an embossing instrument for use with the apparatus of FIG. 1 according to an embodiment of the present invention;

FIGS. 18A and 18B are perspective and side views, respectively, of a perforating instrument for use with the apparatus of FIG. 1 according to an embodiment of the present invention:

FIG. 19 is a partial cross-sectional view of an embossing mat for use with the apparatus of FIG. 1 according to an embodiment of the present invention;

FIG. 20 illustrates the use of the embossing mat of FIG. 19; and

FIG. 21 is a flowchart illustrating the creation of a pattern booklet for use with the apparatus of FIG. 1.

### DETAILED DESCRIPTION OF PREFERRED EMBODIMENTS

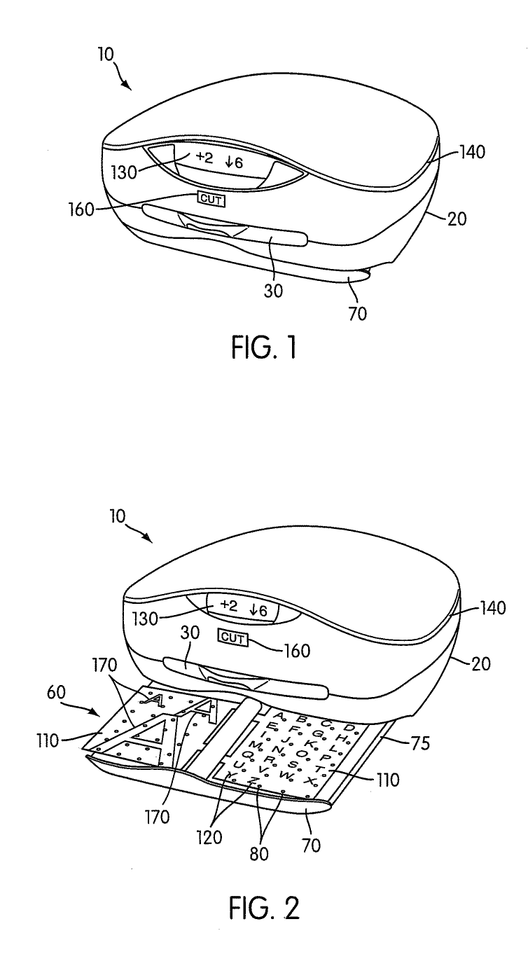

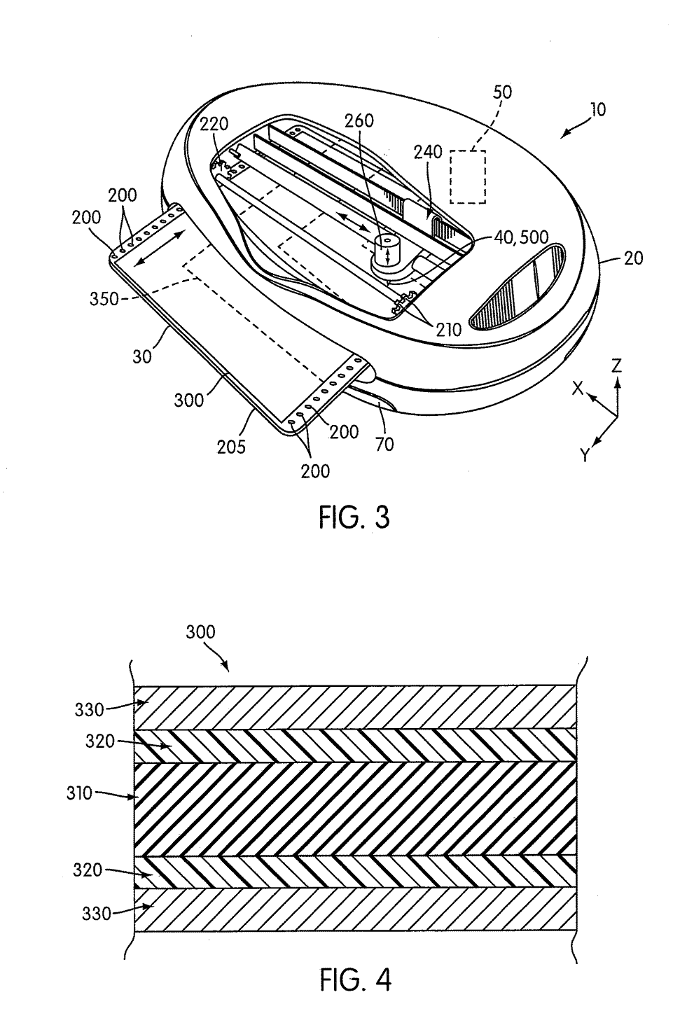

FIGS. 1-3 illustrate an automatic pattern cuffing apparatus 10 according to one embodiment of the present invention. The apparatus 10 comprises a housing 20, a cutting/work piece supporting platform 30 mounted to the housing 20, and a work piece cutter 40 (see FIG. 3). The cutter 40 is movably mounted to the housing 20 to permit the cutter 40 to move relative to the cutting platform 30 in generally orthogonal X and Z directions, and the platform 30 is movable relative to the cutter 40 in a Y direction, which is generally orthogonal to both the X and Z directions. A cutter controller 50 operatively connects to the cutter 40 and the platform 30 to move the cutter 40 and the platform 30 relative to one another in the X, Y, and Z directions. The platform 30, cutter 40, and cutter controller 50, as well as alternative constructions, are discussed later in the application. The apparatus 10 also includes an interchangeable pattern booklet 60 (see FIG. 2) that removably engages an operator interface 70 and the cutter controller 50.

While the illustrated apparatus 10 utilizes a cutter 40 to make patterns in the work piece, alternative pattern making instruments may replace the cutter 40 to interact with the work piece. For example, the cutter 40 may be replaced with pattern making instruments such as a journaling instrument (e.g., pen, pencil, chalk, calligraphy pen, etc.), an embossing instrument, a scoring instrument, or a perforating instrument. If a journaling instrument is used, the apparatus 10 can draw patterns on the work piece. The operator may use these drawn or embossed patterns on the work piece as is, or may manually cut the pattern out of the work piece by using the drawn or embossed pattern as a guide.

As shown in FIGS. 1, 2, and 6, the operator interface 70 comprises a tray 75 that permanently slidably mounts to the housing 20 so that the operator interface may be selectively opened to allow an operator to operate the apparatus 10 (see FIG. 2) or closed to facilitate storage and transport of the apparatus 10 (see FIG. 1). As shown in FIG. 6, the operator interface 70 comprises a set of operator-actuated switches 80 arranged in a two-dimensional array on an upper surface of the tray 75 of the operator interface 70. The switches 80 are operatively connected to the cutter controller 50 to indicate to the cutter controller 50 when any switch 80 is actuated. The switches 80 may comprise any type of suitable operator-actuated switches. The illustrated switches 80 comprise pressure sensitive momentary switches that are disposed below a flexible liner on the operator interface 70. These are often referred to as membrane switches. Alternatively, the switches 80 may comprise momentary switches that extend upwardly from the top of the operator interface 70, which may use depressible buttons. Alternatively, the upper surface of the operator interface 70 may be proximity-sensitive or touch-sensitive (such as by capacitive sensing, or some other means) and indicate to the cutter controller 50 what region of the operator interface 70 is actuated. While the illustrated operator interface 70 slidably mounts to the housing 20, the operator interface 70 may alternatively rigidly or pivotally mount to the housing 20 without deviating from the scope of the present invention.

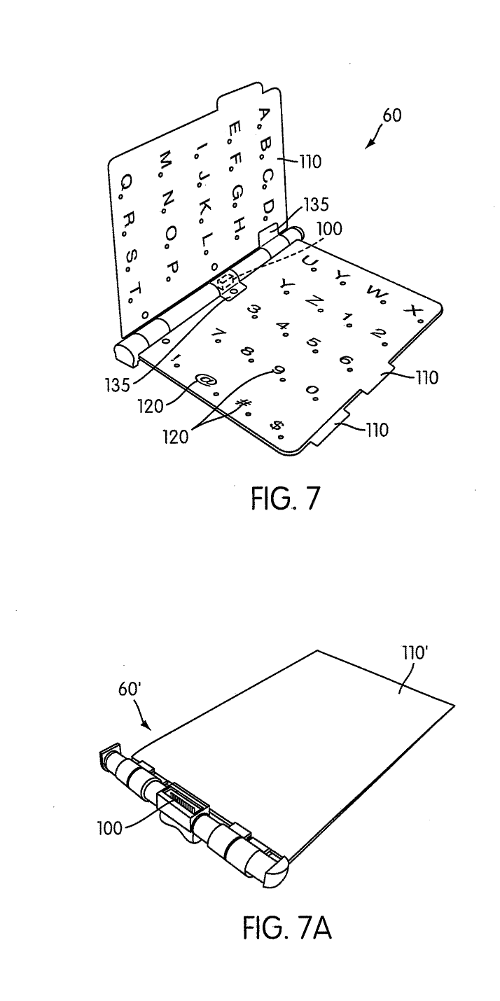

As shown in FIG. 7, the pattern booklet 60 comprises a memory device 100 and a plurality of pages 110 of pattern identifiers 120. The pages 110 may comprise any suitable type of substrate (e.g., paper, plastic, cardstock, cardboard, etc.) and shape (square, oval, rectangular, irregularly curved and/or angled, etc.). While the illustrated pages 110 are connected to each other and to the booklet 60, the pages 100 may alternatively remain discrete stand-alone elements (e.g., a stack of cards, etc.). The pattern identifiers 120 are permanently displayed in two-dimensional sets on each page 110 of the booklet 60. The pattern identifiers 120 may be printed, embossed, glued, etched, stitched, molded, or otherwise applied to the pages 110. The pattern identifiers 120 may include any suitable patterns such as alphabet letters, numbers, geometric patterns, animal patterns, etc. The memory device 100 comprises any suitable memory device such as a flash memory card, ROM memory, a floppy disk, a hard disk drive, etc. The memory device 100 contains a set of cutting (or other pattern making) instructions corresponding to each pattern identified by each pattern identifier 120. The cutter controller 50 selectively reads the memory device 100 to obtain the appropriate set of cutting instructions and control the relative movement between the cutter 40 and the platform 30 to cut a desired pattern.

The patterns and pattern making instructions in the booklet 60 may be designed to make patterns using any one or more different types of pattern making instruments. For example, a single set of pattern making instructions may be used to cut a pattern using the cutter 40, to journal the pattern using a journaling instrument, or to score the pattern using a scoring instrument. Additionally and/or alternatively, pattern booklets 60 (or individual patterns therein) may be specifically designed to make patterns using certain pattern making instruments. For example, certain patterns and pattern making instructions may be specifically designed for use with an embossing instrument or other specific type of pattern making instrument.

As shown in FIGS. 2, 6, and 7, the pattern booklet 60 is selectively and removably mountable to the operator interface 70. When the pattern booklet 60 is mounted to the operator interface 70, the memory device 100 operatively engages a connection port 150 (see FIG. 6) in the operator interface 70, which operatively connects the memory device 100 to the cutter controller 50. Similarly, when the pattern booklet 60 is mounted to the operator interface 70, the pages 110 may be selectively turned such that the set of pattern identifiers 120 on a chosen page 110 physically aligns with the set of switches 80, thereby providing each pattern identifier 120 with an associated switch 80. As shown in FIG. 2, the switches 80 are visible through holes in the pages 110 that are associated with specific pattern identifiers 120. Alternatively, the switches 80 may be disposed below the pattern identifiers 120 so that an operator chooses a pattern by pushing down on the pattern identifier 120 itself, which actuates the switch 80 beneath that pattern identifier 120.

While physical alignment between the illustrated pattern identifiers 120 and switches 80 involves disposing the switches 80 in close physical proximity to the pattern identifiers 120, the switches 80 and pattern identifiers may be physically aligned without such close proximity. For example, a line on the page may run from a pattern identifier 120 to an edge of the page and the associated switch 80 may be disposed adjacent the page 110 and line. Physical alignment merely requires a predetermined spatial link or relationship between the pattern identifier 120 and an associated switch 80 that helps an operator to know which switch 80 is associated with which pattern identifier 120.

While the illustrated pages 110 and pattern identifiers 120 physically align with the set of switches 80 so that each pattern identifier 120 physically corresponds to an associated switch 80, the pattern identifiers 120 may alternatively correspond to the set of switches 80 through a logical, non-spatial relationship. For example, each switch 80 may be numbered. Corresponding numbers could appear next to each pattern identifier 120 in the booklet 60. An operator could peruse the booklet 60, choose a desired pattern and pattern identifier 120, and indicate his/her selection to the apparatus 10 by actuating the correspondingly numbered switch 80. Moreover, in such an alternative, the corresponding switches could comprise a small keypad or other input device that enables the operator to simply type in a number or code corresponding to the pattern identifier 120. Likewise, with any of the above-described embodiments, the memory device 100 could be separate from the booklet 60 and inserted in a port on the apparatus 10, or otherwise engaged with a connector, for allowing the controller 50 to read the appropriate cutting instructions.

In an alternative embodiment, the operator interface 70 comprises a pattern identifier 120 selecting pen/wand. The operator may use the pen/wand to scan a bar code next to a desired pattern identifier 120 in the booklet 60. Alternatively, the operator may place the pen/wand on or near the desired pattern identifier 120 and the pen/wand may sense a corresponding short-range radio frequency ID tag disposed under or near the desired pattern identifier. The pen/wand may interact with the controller 50 via wireless or wired communication to indicate the desired pattern to the controller 50. Generally, any suitable operator interface may be used to allow the operator to select the desired set of instructions for controlling the cutting operation.

While the illustrated operator interface 70 is permanently attached to the housing 20 and removably mountable to the booklet 60, the operator interface 70 may alternatively be incorporated into the booklet 60, itself, such that the operator interface 70, memory device 100, and pages 110 are assembled together into the booklet 60. In such an embodiment, the switches 80 could be disposed beneath the pattern identifiers 120 on the pages 110 or between sandwiched layers of each page 110. The booklet 60 is removably mountable to the housing 20 with the operator interface 70 being operatively connectable to the cutter controller 50 through a port similar to the port 150 for the memory device. Alternatively, because the operator interface 70 is in the booklet 60, the memory device 100 and operator interface 70 may be connected to the cutter controller 50 by other means, such as by a connector cable (e.g., a USB cable) or by a wireless transmitter/receiver connection (e.g., an infrared connection or BLUETOOTH connection). In such alternatives, there is no need for providing a tray 75 or other structure for mounting the booklet 60 to the housing 20.

As shown in FIG. 6, an array of page sensors 125 are disposed on the operator interface 70 to sense which page 110 of the booklet 60 is face up (i.e., viewed by the operator). The sensors 125 operatively connect to the cutter controller 50 to identify the face up page 110 so that the cutter controller 50 uses the sets of cutting instructions on the memory device 100 that correspond to the pattern identifiers 120 on that face up page 110. As shown in FIG. 7, tabs 135 connect each page 110 to the spine of the booklet 60. These tabs 135 align with the sensors 125 such that the sensors 125 sense which page 110 is face up.

In the illustrated embodiment, the sensors 125 comprise light sensors that sense whether a tab 135 covers the corresponding sensor 125. As shown in FIG. 7, holes are disposed in the leftward pages 110 at page positions that are adjacent to tabs 135 of rightward pages 110 so that the leftward pages do not cover the sensors 125 that correspond to the rightward pages 110. Alternatively, the sensors 135 could align with tabs that extend outwardly from the outer edge of the pages 110.

Although the illustrated sensors 125 comprise light sensors, any other suitable sensor could alternatively be used. For example, the sensors 125 could comprise momentary switches that are actuated when the tabs 135 of the pages 110 are turned and lay on the switches. Alternatively, each sensor 125 may be incorporated into the spine of the booklet 60 so that the sensor senses a pivotal position of each page 110 relative to the spine of the booklet 60. Alternatively, each sensor 125 may be a switch that the operator actuates to indicate which page 110 is open. Alternatively, each sensor 125 may comprise any other type of suitable sensor that is capable of indicating to the cutter controller 50 which page 110 the operator is selecting patterns from.

FIG. 7A is a bottom perspective view of a booklet 60′ according to an alternative embodiment of the present invention. The booklet 60′ is generally similar to the booklet 60 except for the shape of its pages 110′. As in the booklet 60, the booklet 60′ includes the memory device 100 disposed in its spine.

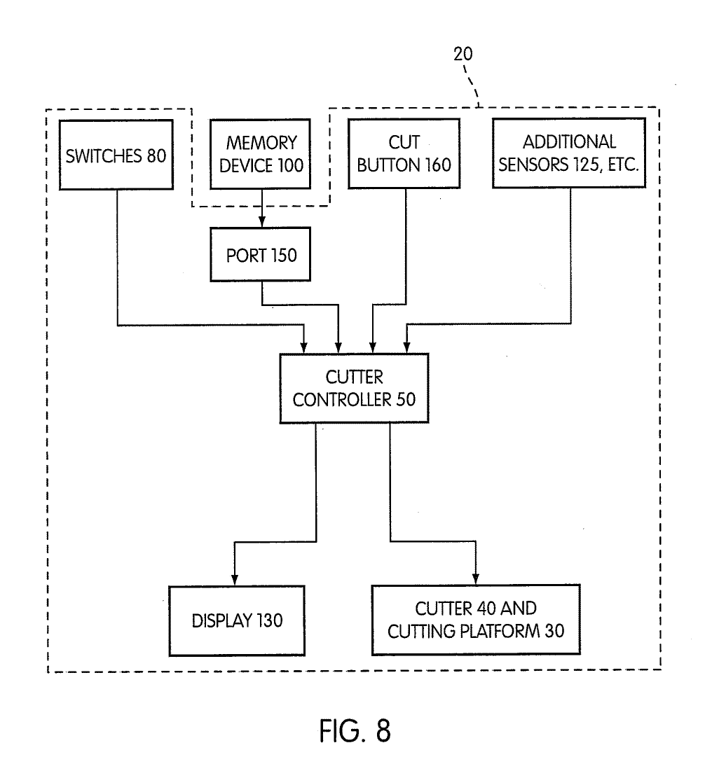

As shown in FIGS. 2 and 8, operator actuation of the switch 80 aligned with a corresponding pattern identifier 120 signals to the cutter controller 50 the pattern desired to be cut. The cutter controller 50 uses the set of cutting instructions on the memory device 100 that corresponds to the associated pattern identifier 120 to control the cutter 40 and/or the platform 30 to cut the desired pattern.

As shown in FIGS. 1, 2 and 8, an LCD display 130 operatively connects to the cutter controller 50. The cutter controller 50 preferably comprises an electronic control unit, such as a microprocessor, that is programmed to perform a plurality of functions of the apparatus 10. The cutter controller 50 displays instructions on the display 130 to help an operator use the apparatus 10. For example, the cutter controller 50 may initially use the display 130 to request that the operator select a desired pattern. The cutter controller 50 may also allow the operator to select additional patterns to be cut from a single work piece, and would make an appropriate determination as to the arrangement of the patterns being cut from the work piece. The cutter controller 50 could calculate work piece usage (i.e., the space available for cutting another pattern) and indicate to the operator using the display 130 when an additional selected pattern will not fit on the work piece. In such a case, the cutter controller 50 may allow the operator to either confirm the already selected pattern(s) or unselect the already selected pattern(s) and start over. The cutter controller 50 may ask the operator via the display to confirm the X and Y dimensions of the work piece to be cut to help the controller 50 determine what patterns will fit onto the work piece.

After the operator has selected all patterns to be cut from a single work piece, the operator actuates a “CUT” button 160 (see FIGS. 1 and 2) on the apparatus 10 that instructs the cutter controller 50 to initiate the cutting procedure. The cutter controller 50 may then indicate to the operator via the display 130 when the cutting procedure is completed. While the illustrated cutter controller 50 utilizes a display to visually communicate with the operator, the cutter controller 50 may alternatively or additionally audibly communicate with the operator through a speaker.

As shown in FIG. 2, the cutter controller 50 allows the operator to chose a size (e.g., ½″, 1″, 2″, and 3″) for each desired pattern by actuating a switch 80 that is associated with one of a plurality of a size identifiers 170 on a page 110 of the booklet 60. Alternatively, separate size-identifying switches/sensors may be mounted to the housing 20 and operatively connected to the cutter controller 50 to enable the operator to choose a pattern size. The memory device 100 may store separate cutting instructions for each size of each pattern. Alternatively, the cutter controller 50 may enlarge or reduce a single set of cutting instructions in the memory device 100 for each pattern to vary the size of the pattern (i.e., a scaling operation).

As shown in FIG. 1, the apparatus 10 includes a movable or removable lid 140 that covers the cutter 40. A lid sensor (not shown) that senses whether the lid 140 is closed may operatively connect to the cutter controller 50. The cutter controller 50 may prevent cutting procedures from starting or continuing if the lid 140 is open. The cutter controller 50 may indicate to the operator via the display 130 that the lid 140 is open and must be closed before the cutter controller 50 can operate the cutter 40.

The lid sensor, as well as other sensors utilized by the apparatus 10, may comprise any type of suitable sensor as would be understood by one of ordinary skill in the art. For example, the lid sensor may comprise an appropriately positioned momentary switch that is physically actuated by the closing of the lid 140. Alternatively, the lid sensor may comprise electrical contacts on the housing and lid that contact each other to complete an electrical circuit when the lid 140 is closed.

The cutter controller 50 may also have various other useful control features and logical functions. These may include an on/off function and/or other control features.

The operator may interact with the cutter controller 50 by actuating appropriate switches 80. Alternatively, the apparatus 10 may also include a discrete keypad connected to the cutter controller 50 that enables the operator to make choices in response to cutter controller 50 instructions on the display 130.

The cutter controller 50 may perform various diagnostic functions at appropriate times during use. For example, if the memory device 100 is not detected or is faulty and cannot be read, the cutter controller may instruct the operator via the display 130 to insert and/or replace the memory device 100. The cutter controller 50 may similarly determine whether a booklet 60 is operatively connected to the apparatus 10.

Additional pattern booklets 60 may be provided with additional patterns and corresponding pattern making instructions so that the apparatus 10 has an even larger selection of patterns. The modular design of the apparatus 10 enables a user to quickly and easily mount other pattern booklets 60 to the operator interface 70 in place of the booklet 60.

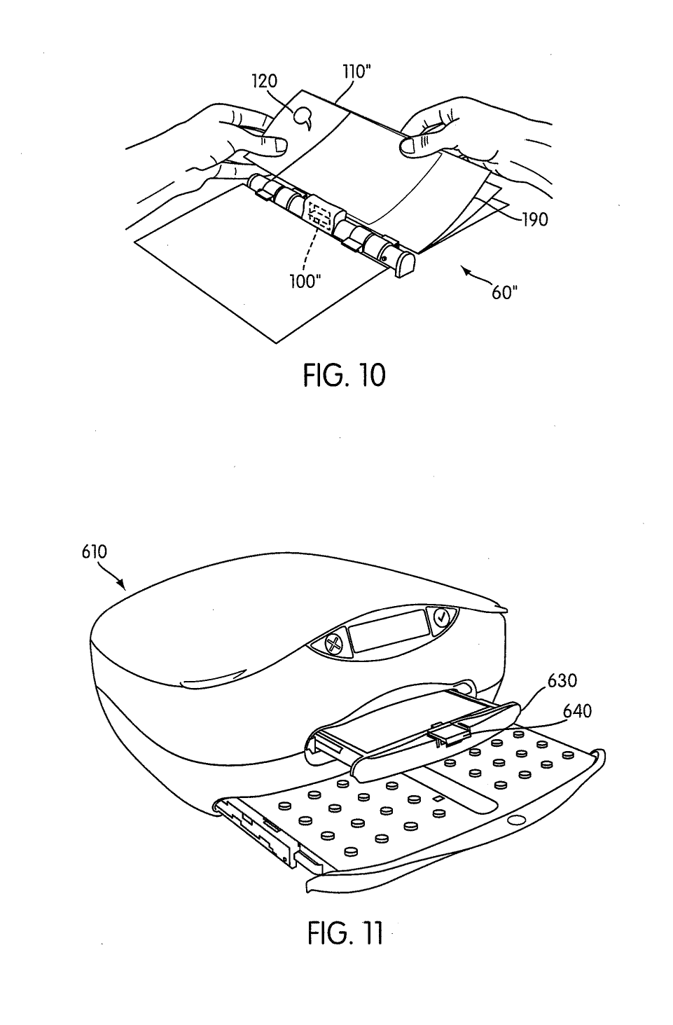

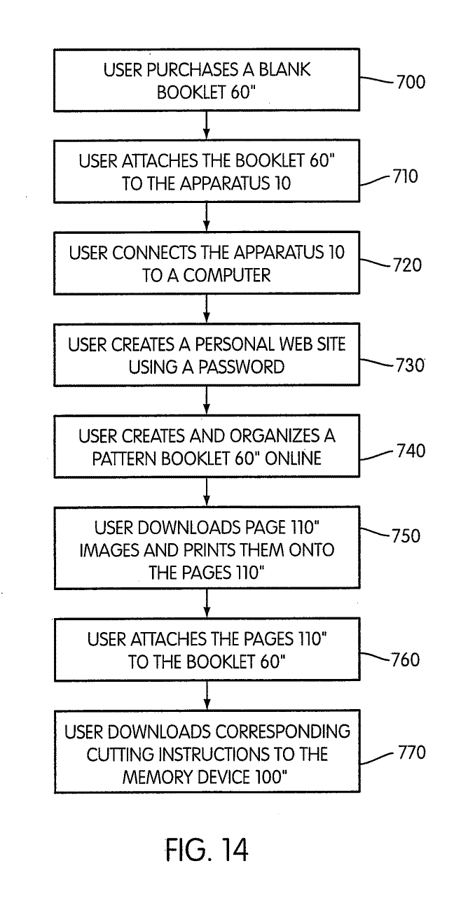

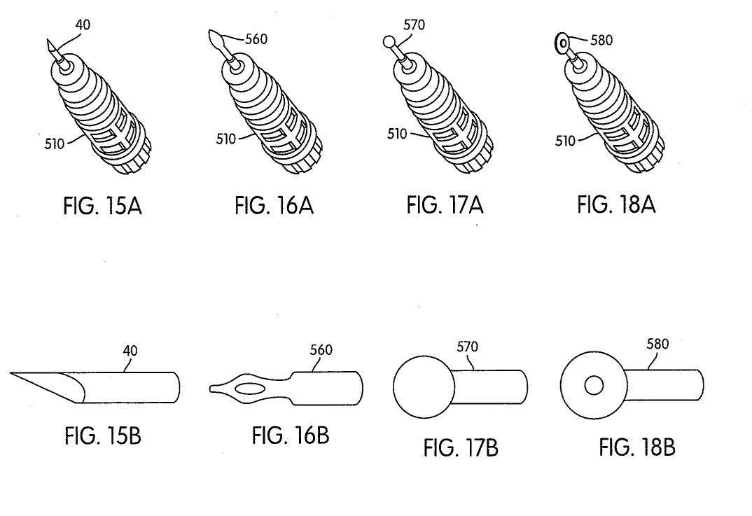

As shown in FIGS. 10, 14, and 21, an Internet- or software-based system could be used to enable the end operator to create personalized booklets 60″ by downloading/creating sets of cutting instructions for storage onto a memory device 100″ and corresponding images (i.e., pattern identifiers 120) for printing onto blank pages 110″. FIG. 14 illustrates a method for supplying personalized pattern booklets 60″ to users according to one embodiment of the present invention. FIG. 21 illustrates a corresponding flow of information/components.

At step 700, a user purchases or otherwise obtains a blank booklet 60″. This method may also use a blank page that is not in a booklet.

At step 710, the user attaches the booklet 60″ with blank memory device 100″ to the apparatus 10. At step 720, the user connects the apparatus 10 to a computer via a USB connection 180 (see FIG. 13). Alternatively, the blank memory device 100″ may connect directly to the operator's computer via a direct USB connection (similar to USB flash memory devices) or through a specialized or standard cable designed to connect the memory device 100″ to a computer. The memory device 100″ may detachably connect to the booklet 60″ to facilitate direct connection to a computer. The “blank” memory device 100″ may include a software program that facilitates downloading patterns to the memory device 100″. The memory device 100″ may also be a commercially available storage card, such as a CompactFlash card, SD card, USB flash memory card, etc., that is received in a card reader on or connected to the computer or otherwise connected to the computer. The booklets 60″ could be designed to releasably engage such commercially available memory devices and a port 150″ like the port 150 could be designed to accept such commercially available memory devices when the booklet 60″ is attached to the apparatus 10.

At step 730, the user uses a password to enter a private web site operated by the supplier of the booklets 60″ (or other appropriate vendor). The password and private web site enable the user to work within a personalized web environment to create and/or organize the patterns that will be added to the blank booklet 60″. The supplier may provide such a password with each blank booklet 60″ so that the cost of each booklet 60″ includes a charge for downloading patterns to the booklet 60″. Alternatively, the password can be linked to a pattern subscription service such that the supplier charges users for downloading patterns using any suitable payment system (e.g., charge per pattern downloaded, monthly/yearly charge for access to all available patterns, etc.). Alternatively, the supplier's web site could allow anyone to design booklets 60″, but require payment (or an authorizing password) before allowing the design to be downloaded to a user's memory device 100″.

At step 740, the user creates and organizes the pages 110″ of the booklet 60″ online. This may include choosing which pattern identifiers 120 to include in the booklet 60″ as well as choosing which order the pattern identifiers will be placed on the pages 110″. In the illustrated embodiment, the step is conducted online via the supplier's web site. Alternatively, this operation could be driven by software on the user's computer or on the memory device 100″ itself, which assembles pattern identifiers and sets of cutting instructions to generate electronic data including the pattern identifiers and corresponding sets of cutting instructions. The software could interact with the supplier's web site to identify available patterns and download specific sets of cutting instructions and pattern identifiers. Alternatively, as shown in FIG. 21, the software could obtain sets of cutting instructions and pattern identifiers from a portable storage device (e.g., diskette, CD, DVD, flash memory, etc.) attached to the user's computer instead of downloading them from a remote computer via the Internet.

Additionally and/or alternatively, the software and/or web site may enable a user to design his/her own patterns. The program or web site would then create corresponding pattern making instructions based on the user-created pattern.

At step 750, the user downloads page 110″ images and prints them onto pages 110″. At Step 760, the user attaches the pages 110″ to the booklet 60″. As shown in FIG. 10, the pages 110″ may slide into appropriate sheet receiving pockets 190 of the booklet 60″. Alternatively, the booklet 60″ may be designed to attach to pages 110″ using any other suitable fastening technique (e.g., staples, three-ring binder holes, glue, double sided tape, etc.). The chosen fastening technique is preferably designed to result in registration that ensures that each pattern identifier 120 aligns with the appropriate switch 80 on the operator interface 70. The booklet 60″ may include an alignment grid to help users to properly position pages 110″ in the booklet 60″.

At step 770, the user downloads cutting instructions corresponding to the pattern identifiers on the pages 110″ to the memory device 100″. The cutting instructions are correlated to the physical location of the corresponding pattern identifiers 120 on the pages 110″ such that selecting a pattern identifier 120 using the operator interface 70 causes the controller 50 to select the appropriate corresponding set of pattern making instructions from the memory device 100″.

The booklets 60″ may be single-use booklets that only permit patterns to be downloaded onto the memory device 100″ once. Software or other suitable mechanisms in the memory device 100″ or elsewhere can be used to prevent additional downloads to the booklet 60″. Alternatively, the booklets 60″ may be reusable, such that the user can create entire new combinations of patterns by downloading new instructions to the memory device 100″ and adding new pages 110″ to the booklet 60″.

The provision of such a large number of possible patterns and pattern sizes on the pages 110, 110″ of the booklet 60, 60″ and memory device 100, 100″ presents a substantial improvement over conventional die-based cutters, whose repertoire of patterns and sizes is limited to the available discrete dies. In contrast, a large number of patterns and cutting instructions can be stored in the memory device 100, 100″ and pages 110, 110″ of a single compact booklet 60, 60″ of the apparatus 10.

The controller 50 may be upgraded/updated in any suitable manner to improve/expand the functionality of the controller 50. For example, software updates may be provided to the controller 50 via a memory device 100 with such updates stored thereon. An update may be transferred to the memory device 100 from a separate computer that obtains the update electronically. Alternatively, the controller 50 may connect directly to the computer via a suitable connection (e.g., serial connection, USB connection 180 (shown in FIG. 13), infrared connection, Bluetooth connection, WIFI, etc.) and obtain updates directly from the computer. Alternatively, the apparatus 10 may include telephone/modem ports, Ethernet ports, or other network or communication connections and associated networking hardware that enables the controller 50 to directly obtain updates over a communication network (e.g., Internet, telecommunications network, bulletin board system, etc.). Such communications connections may also be used to obtain additional patterns and pattern making instructions from a geographically distant source (e.g., an internet web site; a networked computer, etc.). The memory device 100″ may also use any of the above techniques to download pattern making instructions.

Operation of the cutter 40 is described hereinafter with reference to FIG. 3.

As shown in FIG. 3, the cutting platform 30 comprises a substantially flat, rigid platform that extends in X and Y directions and is movable relative to the housing 20 and cutter 40 in the Y direction. A plurality of surface features 200 extend linearly in the Y direction along the outside edges of a rigid substrate 205 of the cutting platform 30. The surface features 200 engage corresponding surface features 210 on a motorized wheel or spur gear 220 such that rotation of the wheel 220 moves the cutting platform in the Y direction. The cutter controller 50 operatively connects to the motorized wheel 220 to control the Y position of the cutting platform relative to the cutter 40. The illustrated surface features 200 comprise linearly spaced openings (e.g., holes or recesses) in the substrate 205, but may alternatively comprise any other suitable surface features (e.g., teeth, protrusions, extrusions, etc.) that are engageable with a corresponding surface feature 210 (spur gear teeth, extrusions, protrusions, etc.) of the wheel 220. While the illustrated cutting platform 30 is substantially flat, the cutting platform may alternatively comprise a cylindrical wheel that rotates to control the Y position of a work piece.

As shown in FIG. 3, the cutter 40 mounts to the housing 20 to allow relative movement in the X and Z directions. A motorized rack and pinion system 240 drives the cutter 40 in the X direction. The motorized rack and pinion system 240 operatively connects to the cutter controller 50 so that the cutter controller 50 controls the X position of the cutter 40. While a rack and pinion system 240 is illustrated, any other suitable linear drive system may alternatively be used without deviating from the scope of the present invention (e.g., linear actuator, belt/pulley system, etc.).

The cutter 40 may also move in the Y direction relative to the housing, thus avoiding the need for the platform 30 to move in the Y direction. In such an embodiment, the platform 30 may nonetheless be movable in the Y direction between a closed position (similar to that shown in FIG. 1) and an open position (similar to that shown in FIG. 3) to allow an operator to place a work piece on the platform 30 and remove cut patterns from the platform 30. A sensor may sense the closed/open position of the platform 30 and operatively connect to the cutter controller 50. The cutter controller 50 may prevent cutting procedures from starting or continuing if the sensor senses that the platform 30 is not in its closed position.

As shown in FIG. 3, a solenoid 260 selectively moves the cutter 40 in the Z direction to selectively position the cutter 40 in a downward cutting position or an upward stowed position. The cutter controller 50 operatively connects to the solenoid 260 to control the Z position of the cutter 40. While a solenoid 260 is used in the illustrated embodiment to drive the cutter in the Z direction, any other suitable driving mechanism may alternatively be used without deviating from the scope of the present invention.

The motorized wheel 220, rack and pinion system 240, and solenoid 260 enable the cutter controller 50 to control the position of the cutter 40 relative to the cutting platform 30 in all three orthogonal X, Y, and Z directions. The sets of cutting instructions on the memory device 100 include X, Y, and Z instructions that enable the cutter controller 50 to use the cutter 40 to cut desired patterns out of a work piece on the cutting platform 30.

The cutter 40 may optionally be mounted to the solenoid 260 to allow relative rotational movement about the Z axis. A servo-motor or other rotational drive element preferably controls the rotational position of the cutter 40 so that the cutter 40 appropriately aligns with the direction that the cutter 40 is moving in the X-Y plane. The set of cutting instructions for each pattern on the memory device 100 may include rotational instructions for appropriately controlling the rotational position of the cutter 40. Alternatively, the cutter controller 50 may calculate the appropriate cutter 40 rotational position based on the X-Y-Z cutting instructions. Alternatively, there may be no active control of the rotational position of the cutter 40 and the cutter 40 may simply be freely rotatable so that it aligns itself with the cutting direction during cutting in a manner similar to how a castor wheel aligns itself with a rolling direction.

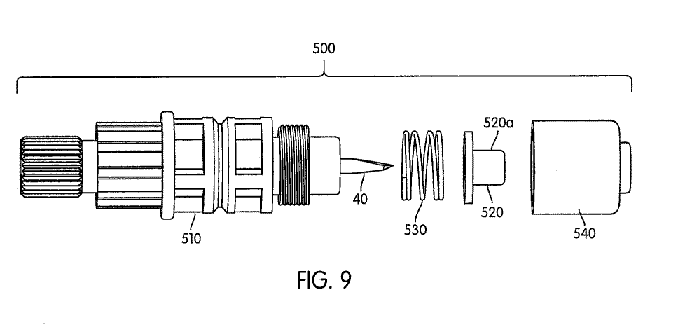

FIG. 9 is an exploded view of a cutting assembly 500 according to an embodiment of the present invention. 40. The cutting assembly 500 includes a base 510 (or pattern making instrument support) that operatively connects to the apparatus 10. The cutter 40 releaseably mounts to the base 510 to facilitate replacement of a worn/dull cutter 40 with a new cutter 40 or an alternative pattern making instrument. The cutter 40 may be held in place via a friction fit or via any suitable positive locking mechanism. A floating cap 520 fits over the cutter 40 and includes a through bore through which the cutter 40 extends. A spring (or other suitable resilient member) 530 is disposed between the floating cap 520 and the base 510 to urge the floating cap 520 away from the base 510 (in a downward direction toward a work piece as shown in FIG. 3). A cap 540 operatively mounts to the base 510 to limit the floating range of the floating cap 520. The cap 540 includes a through bore that is sized to allow a cylindrical portion 520a of the floating cap 520 to fit therethrough while preventing a larger shoulder 520b of the floating cap 520 from extending therethrough. When the apparatus 10 is operated, the floating cap 520 pushes down on the work piece to hold the work piece in place during the cutting procedure. The floating cap 520 rises and falls vertically (as shown in FIG. 3) to follow the contour of the work piece, even if the thickness of the work piece varies. The floating cap 520 may be omitted without deviating from the scope of the present invention.

The work piece is preferably a thin, substantially planar work piece such as paper, cardstock, construction paper, adhesive paper, etc. The cutter 40 is preferably a paper cutter that is constructed to cut through such a work piece, and may include a blade with a sharp cutting edge.

As shown in FIGS. 3 and 4, the cutting platform 30 includes a cutting mat 300 disposed on a top surface of the rigid substrate 205 of the cutting platform 30. FIG. 4 illustrates a cross-sectional view of the cutting mat 300. The cutting mat 300 comprises a central layer of self-healing material 310, adhesive layers 320 disposed above and below the central self-healing layer 310, and removable protective layers 330 disposed above and below the adhesive layers 310. The self-healing layer 310 preferably comprises a self-healing vinyl that may be repeatedly cut by the cutter 40 before it must be replaced. The self-healing layer 310 may alternatively comprise any other suitable resilient material that essentially returns to its original shape after being cut.

The adhesive layers 320 preferably comprise a relatively low tack adhesive that has a tacky surface that secures the work piece in place relative to the cutting platform 30 during cutting operations, and release the work piece without damage after cutting. For example, the adhesive layers 320 may comprise a microsphere adhesive or a soft rubber compound. If the adhesive layer 320 comprises a soft rubber compound, the layer 320 may be cleaned if it becomes clogged with debris such as dust, fibers, etc. that adversely affects the adhesive properties of the layer 320.

The adhesive layer 320 presents several advantages over conventional cutting mats. The adhesive layer 320 adheres to the underside of the work piece without obstructing any of the work piece from a cutter. Consequently, the entire area of the work piece may be cut. Conversely, in conventional cutters that clamp a work piece in place, the clamped portions of the work piece cannot be cut, which results in waste and limits the size of cut patterns. The adhesive layer 320 also advantageously securely holds the entire surface area of the work piece so that the work piece will not wrinkle while being cut. Conversely, in conventional cutters that utilize clamps to secure the work piece, portions of the work piece that are not clamped down may wrinkle during cutting. The adhesive layer 320 helps the apparatus 10 cut paper products that do not include a sacrificial backing layer or an additional adhesive, as is frequently required by conventional cutters.

The removable protective layers 330 cover the adhesive layers 320 to discourage debris/contaminants from sticking to the adhesive layers 320 when the apparatus 10 is not being used. Accordingly, the top removable protective layer 330 is removed prior to use of the apparatus 10 and subsequently replaced after the apparatus 10 is used. The bottom removable protective layer 330 may be removed before the substrate 205 is mounted to the mat 300 so that the bottom adhesive layer 330 secures the substrate 205 to the mat 300. After the top adhesive layer 320 loses its tackiness, the mat 300 may be flipped over so that the bottom adhesive layer 320 is used to secure a work piece to the cutting platform 30. When both adhesive layers lose their tackiness, the mat 300 should be replaced with a new mat 300.

While the illustrated mat 300 is double-sided, a single-side mat could alternatively be used without deviating from the scope of the present invention. For example, the bottom adhesive layer 320 and removable protective layer 330 could be omitted to create a single-sided cutting mat.

While a tacky cutting platform 30 is preferred, the cutting platform may alternatively use work piece clamps to clamp a work piece to the cutting platform. Furthermore, any other suitable securing means (e.g., vacuum table, clamping rollers, etc.) may be used to secure the work piece to the cutting platform without deviating from the scope of the present invention.

As shown in FIG. 3, a plurality of registration marks 350 are disposed on the top surface of the mat 300. The registration marks 350 comprise nested rectangles that identify where on the mat 300 variously sized work pieces should be placed. The registration marks 350 also indicate to the operator the size of the work piece to help the operator indicate to the cutter controller 50 the size of the available work piece.

As shown in FIG. 3, sufficient rotation of the spur gear 220 disengages the cutting platform 30 from the apparatus 10 in the Y direction to allow the operator to replace the mat 300, insert a blank work piece, and/or remove cut patterns.

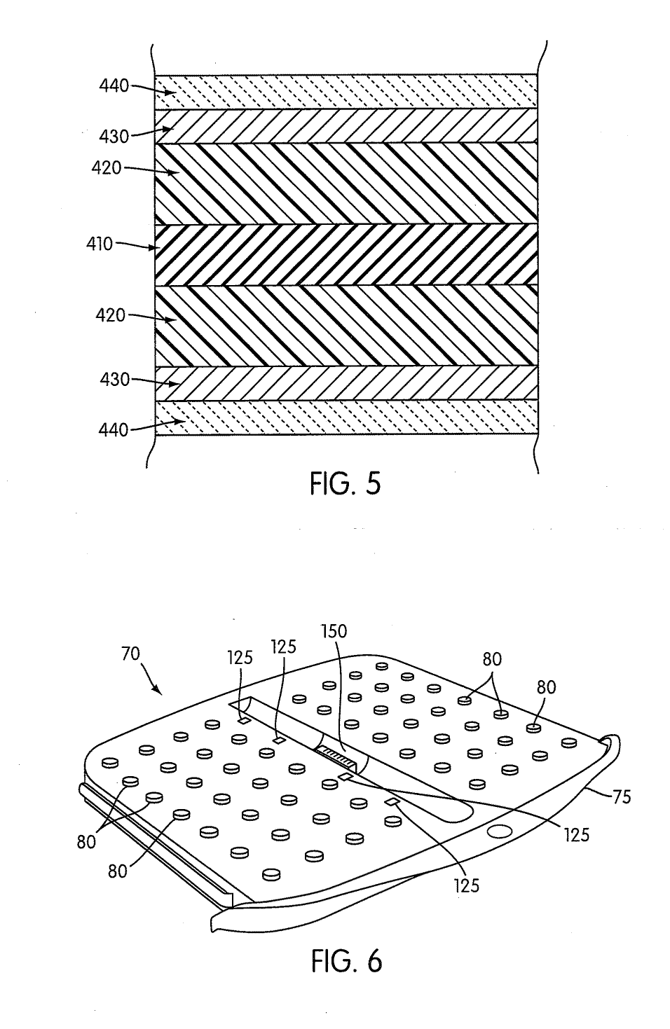

FIG. 5 illustrates a cutting mat 400 according to an alternative embodiment of the present invention. The cutting mat 400 is a two-sided cutting mat that is designed for manual use by an operator with a utility knife or other suitable cutting instrument, but could be used in the apparatus 10 described above. The cutting mat 400 comprises a central rigid substrate 410, upper and lower self-healing layers 420, upper and lower adhesive layers 430, and upper and lower removable protective layers 440. Like the rigid substrate 205 of the cutting platform 30, the central rigid substrate 310 preferably comprises a strong light material such as plastic, that discourages a manual cutting blade from piercing through the entire cutting mat 400. The central rigid substrate 410 is particularly advantageous when an operator is manually cutting a work piece because the cutting blade's depth is not controlled. The self-healing layers 420, adhesive layers 430, and protective layers 440 are similar or identical to the analogous layers of the cutting mat 300. The cutting mat 400 secures a work piece while the operator uses a manual cutting instrument to cut the work piece into a desired pattern. While the illustrated cutting mat 400 is two-sided, the lower self-healing layer 420, lower adhesive layer 430, and lower protective layer 440 may be omitted to create a one-side cutting mat without deviating from the scope of the present invention.

As an alternative, the cutting mat 300, 400 itself could serve as the platform 30 for the apparatus 10. When the operator wants to replace the mat 300, 400, the cutter controller 50 could be operated to discharge the mat 300, 400 in the Y direction, and then the replacement mat 300, 400 could be fed back into the apparatus 10. Such a mat 300, 400 could be provided with the surface features 200 for improved control.

The cutter 40 may be interchangeably mounted to the apparatus 10 to allow an operator to easily and quickly replace the cutter 40 with a new, sharp cutter 40.

The cutter 40 may also be interchangeable with other types of pattern making instruments (e.g., an embossing instrument 570 (FIGS. 17A&B), a perforating instrument 580 (FIGS. 18A&B (perforating features being disposed along the circumference of the “pizza cutter” style wheel)), or a journaling instrument 560 (FIGS. 16A&B)), which may be quickly and easily attached to the apparatus 10 in place of the cutter 40 using any suitable releasable holding mechanism. As discussed above, the cutting mat 300 is designed for use with the cutter 40. The cutting mat 300 may be interchangeable with other types of pattern making mats that are better suited to the selected pattern making instrument. A storage compartment may be provided on the apparatus 10 to store the pattern making instruments 40, 570, 580, 560 that are not being used.

If a journaling instrument is used, a mat having a harder, but tacky, upper surface may be used so that the journaling instrument does not pierce the work piece. A journaling mat could be incorporated into the platform 30, so that a journaling instrument could be used by simply removing the mat 300. Alternatively, a replaceable journaling mat could be used. A replaceable journaling mat may be identical to the mat 400 shown in FIG. 5, except without the self-healing layers 420. Accordingly, a two-sided journaling mat could include, in sequential order, a protective layer 440, an adhesive layer 430, a rigid substrate 410, an adhesive layer 430, and a protective layer 440.

Alternatively, a mat could include a cutting mat on one side and a journaling mat on the other side. Such a mat could be identical to the mat 400 shown in FIG. 5, except without one of the relatively soft, self-healing layers 420. A user could simply flip the mat over to switch between mat surfaces designed for cutting and journaling.

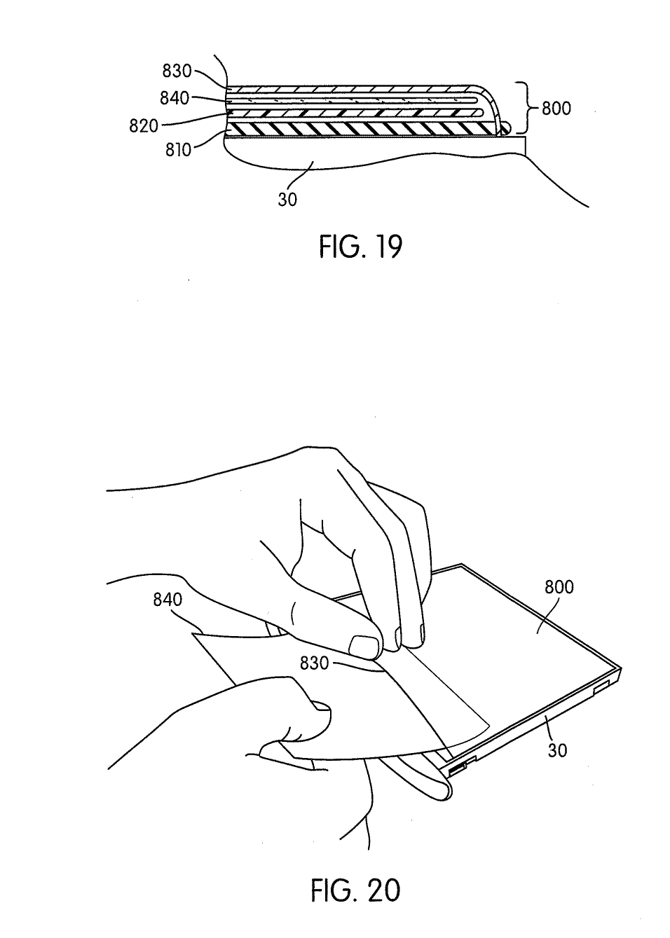

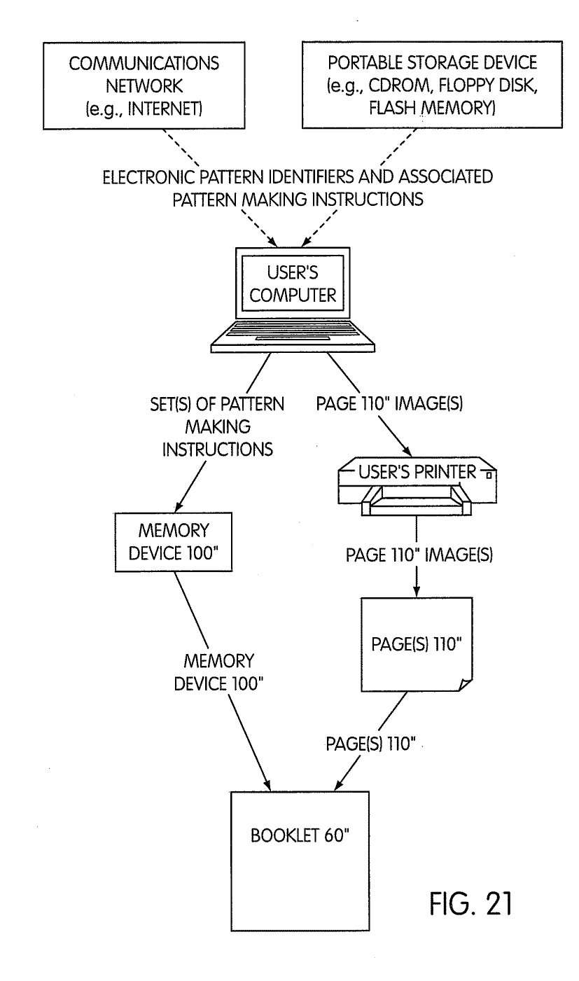

If an embossing instrument is used, a user may place a work piece onto the mat 300 and then place a low-friction protective cover such as a thin deformable protective sheet (e.g., a thin plastic sheet) on top of the work piece. The protective sheet reduces friction between the embossing instrument 570 (see FIG. 17) and the work piece so that the instrument 570 embosses the work piece without tearing it. Alternatively, as illustrated in FIGS. 19 and 20, an embossing mat 800 may be placed on the platform 30 to facilitate embossing operations. As shown in FIG. 19, the embossing mat 800 includes a rigid substrate layer 810, a relatively soft, resiliently deformable layer 820 (e.g., foam, soft rubber) attached to or placed on the substrate layer 810, and a low-friction, resiliently deformable protective top layer 830. As shown in FIG. 20, the top layer 830 may be attached to the substrate layer 810 along three sides to create a pocket into which a work piece 840 such as paper may be slid. Alternatively, the top layer 830 may attach to two, one, or no sides of the substrate layer 810 without deviating from the scope of the present invention. An adhesive may be applied to the bottom of the substrate layer 810 to help secure the mat 800 to the platform 30. The resiliently deformable layer 820 may be a self-healing layer similar to the self-healing layer 420 so that the mat 800 may be used as a cutting mat by removing the top layer 830. An adhesive layer like the adhesive layer 320 may be attached to the upper and/or lower surface of the resiliently deformable layer 820 to secure a work piece to the mat 800 and/or secure the resiliently deformable layer 820 to the rigid substrate layer 810.

According to one embodiment of the present invention, the mat 800 may be flipped over for use during journaling procedures. The hardness of the substrate layer 810 facilitates the use of a journaling instrument 560 (see FIG. 16) without deforming the work piece. A tacky adhesive layer may be applied to the bottom surface of the substrate layer 810 to help hold the work piece in place during journaling procedures.

A user selects the appropriate combination of mat and pattern making instrument and attaches both to the apparatus 10 in order to perform the desired pattern making operation. When the user wishes to perform a different type of pattern making operation, the user simply replaces the attached mat and pattern making instrument with the appropriate new combination of mat and pattern making instrument.

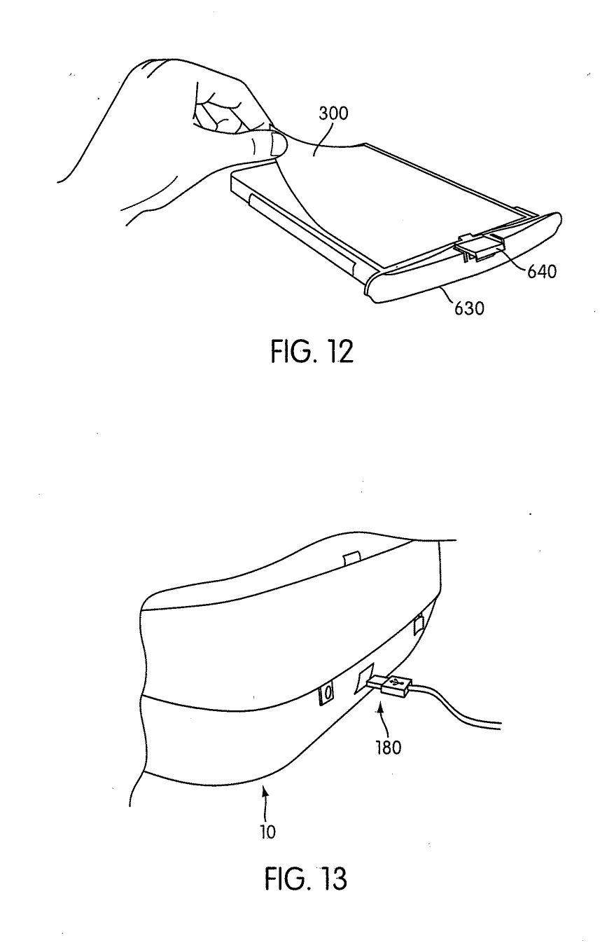

FIG. 11 illustrates an apparatus 610, which is generally similar to the apparatus 10. Accordingly, a redundant description of similar features is omitted. The apparatus 610 includes a work piece supporting platform 630, which is generally similar to the platform 30 except that the platform 30″ includes a user-operated lock 640 that releaseably locks the platform 630 into its closed/operative position. Sensors (not shown) may prevent the apparatus 610 from initiating pattern making operations unless the platform 630 is in its closed position 630 and/or the lock 640 is in its locked position. As shown in FIG. 12, cutting mats 300 on the platform 630 may be replaced as discussed above with respect to the platform 30.

The foregoing description is included to illustrate the operation of the preferred embodiments and is not meant to limit the scope of the invention. To the contrary, those skilled in the art should appreciate that varieties may be constructed and employed without departing from the scope of the invention, aspects of which are recited by the claims appended hereto.

What is claimed is:

1-23. (canceled)

24. A pattern cutting system for cutting patterns from a substantially planar work piece, comprising:
a pattern cutting apparatus comprising:
(i) a housing,
(ii) a platform for supporting the substantially planar work piece,
(iii) a work piece cutter supported by the housing and constructed to cut a pattern from the work piece, the work piece cutter and the platform being movable relative to one another in generally orthogonal X, Y, and Z directions,
(iv) a cutter controller operable to move the cutter and platform relative to one another in the X, Y, and Z directions for cutting the workpiece with the cutter, and
(v) an operator interface operatively connected to the controller, the operator interface including a set of switches;
a memory device removably operatively connected to the controller, the memory device comprising a plurality of sets of pattern cutting instructions, each useable by the controller for moving the cutter and platform relative to one another for cutting a corresponding pattern from the work piece, each of the switches being associated with a corresponding one of the sets of pattern cutting instructions; and
a first overlay sheet with a first set of pattern identifiers provided thereon, each of the first set of pattern identifiers being associated with a corresponding set of pattern cutting instructions in the memory device, wherein the first overlay sheet removably overlies the operator interface such that each of the first set of pattern identifiers is physically associated with a corresponding switch,
wherein the operator interface enables an operator to select one of the sets of instructions to be used by the controller to move the cutter and the platform relative to one another to cut the corresponding pattern from the work piece by actuating one of the switches that is physically associated with a desired pattern identifier,
wherein at least the work piece cutter, the cutter controller, and the operator interface are mounted on or in the housing for manual transport as a portable unit, and
wherein the removable connection of the memory device to the cutter controller and removable overlaying of the first overlay sheet on the operator interface enable manual removal and replacement of the memory device and the first overlay sheet with other interchangeable memory devices and overlay sheets.

25-27. (canceled)

28. The pattern cutting system of claim 26, wherein at least the memory device and first overlay sheet are assembled together and removable from the apparatus as a unit.

29-30. (canceled)

31. The pattern cutting system of claim 24, wherein each pattern identifier overlies a corresponding switch.

32. The pattern cutting system of claim 24, wherein the controller is capable of scaling the sets of pattern cutting instructions to vary a size of a pattern cut from the work piece.

33-81. (canceled)

82. The pattern cutting system of claim 24, wherein:
a movable portion on the housing is selectively movable between an open position providing access to the operator interface for operation thereof and a closed position concealing the operator interface for storage or transport of the apparatus.

83. The pattern cutting system of claim 82, wherein the movable portion on the housing is a tray mounted for sliding movement between the open and closed positions, the switches of the operator interface being provided on an upper surface of the tray.

84. The pattern cutting system of claim 82, further comprising a second movable portion selectively movable between an open position providing access to the pattern cutting instrument in an interior of the housing and a closed position preventing such access to the pattern cutting instrument.

85. The pattern cutting system of claim 84, wherein the second movable portion is a lid pivoted atop the housing.

86. The pattern cutting system of claim 24, wherein the cutting platform comprises a substantially flat platform.

87. The pattern cutting system of claim 24, wherein the cutting platform is detachably mounted to the housing.

88. The pattern cutting system of claim 24, further comprising a display supported by the housing and controlled by the cutter controller, wherein the cutter controller is configured to indicate to the operator via the display when selected pattern(s) have been cut.

89. The pattern cutting system of claim 24, wherein the cutter controller comprises an input device that is configured to enable the operator to indicate to the cutter controller the X and Y dimensions of the single work piece.

90. The pattern cutting system of claim 24, wherein the cutter controller is configured to allow the operator to select a plurality of desired patterns to be cut from a single work piece, and wherein the cutter controller is configured to move the instrument and platform relative to one another to sequentially cut the plurality of desired patterns from the single work piece.

91. The pattern cutting system of claim 24, wherein the apparatus further comprises a display supported by the housing and operatively connected to the cutter controller, the cutter controller being configured to determine when no memory device is detected as being operatively connected to the controller, and in response indicate to the operator via the display that no memory device is detected.

92. The pattern cutting system of claim 24, wherein the first set of pattern identifiers are permanently displayed on the first overlay sheet.

93. The pattern cutting system of claim 92, wherein the first set of pattern identifiers are printed, embossed, glued, etched, stitched, or molded onto the first overlay sheet.

94. The pattern cutting system of claim 24, wherein each of the first set of pattern identifiers is positioned over the corresponding switch thereof such that the operator may select a pattern to be cut by pushing down on the desired one of the pattern identifiers.

95. The pattern cutting system of claim 24, wherein the set of switches comprises a set of depressible buttons that extend upwardly from the operator interface.

96. The pattern cutting system of claim 95, wherein the first overlay sheet has openings therein for receiving the depressible buttons.

97. The pattern cutting system of claim 24, wherein the first overlay sheet has holes through which the set of switches are accessible.

98. The pattern cutting system of claim 24, wherein the cutter controller is configured to make a determination of whether selected pattern(s) will fit on the single work piece.

99. The pattern cutting system of claim 98, wherein the cutter controller is programmed to use the determination to indicate to the operator that selected pattern(s) will not fit onto the single work piece.

100. The pattern cutting system of claim 99, further comprising a display controlled by the cutter controller, wherein the cutter controller is configured to visually notify the operator via the display when the selected pattern(s) will not fit onto the single work piece.

101. The pattern cutting system of claim 24, further comprising:
a second memory device comprising a second plurality of sets of cutting instructions different from the plurality of sets of cutting instructions; and
a second overlay sheet with a second set of pattern identifiers displayed thereon, each of the second set of pattern identifiers being associated with a corresponding set of cutting instructions in the second memory device,
wherein the second memory device and second overlay sheet are selectively mountable to the apparatus in place of the memory device and the first overlay sheet to provide the cutting apparatus with a wider repertoire of patterns.

102. The pattern cutting system of claim 24, wherein the cutting platform has a tacky surface that is constructed and arranged to releasably secure the work piece in place relative to the cutting platform when the cutter cuts the work piece.

103. The pattern cutting system of claim 24, wherein the cutting platform comprises:
a substrate; and
an adhesive layer disposed on the substrate, the adhesive layer being constructed and arranged to releasably hold the work piece in a fixed position thereon during cutting of the work piece.

104. The pattern cutting system of claim 103, wherein the surface of the platform includes registration marks that indicate to the operator where to place the work piece.

105. The pattern cutting system of claim 24, further comprising a size-selection sensor operatively connected to the cutter controller to enable the operator to select a pattern size for a selected pattern, the cutter controller being configured to cut the selected pattern in a size associated with the selected pattern size.

106. The pattern cutting system of claim 24, wherein:
the cutting platform is movable relative to the housing in the Y direction; and
the cutter controller selectively moves the instrument relative to the housing and cutting platform in the X and Z directions.

107. The pattern cutting system of claim 106, wherein the cutting platform is sufficiently movable in the Y direction that the cutting platform may be selectively disengaged from the housing to allow the operator to replace the platform, adhere a new work piece to the platform, or remove cut patterns from the platform.
